(19) United States
(12) Patent Application Publication
(10) Pub. No.: US 2014/0320779 A1
(43) Pub. Date: Oct. 30, 2014

(54) DISPLAY DEVICE

(71) Applicant: Mitsubishi Electric Corporation, Tokyo (JP)

(72) Inventor: Shigeaki NOUMI, Tokyo (JP)

(73) Assignee: Mitsubishi Electric Corporation, Tokyo (JP)

(21) Appl. No.: 14/259,512

(22) Filed: Apr. 23, 2014

(30) Foreign Application Priority Data
Apr. 25, 2013 (JP) 2013-092763

(51) Int. Cl. G02F 1/133

(52) U.S. Cl. CPC G02F 1/13306
USPC 349/58

(57) ABSTRACT

A display device includes: a plurality of tape members is provided along one side of a display panel, wherein a first tape member is provided at an end portion in an extending direction of the one side, wherein the first tape member has: a first side where the input terminal is provided; a second side where the output terminal is provided; and an outer side, which is close to the end portion in the extending direction of the one side, wherein at least a part of the outer side is inclined with respect to another side of the first tape member, so that a width of the first side is narrower than a width of the second side, and wherein the outer side is closer to the end portion than an end side of the display control substrate, in the extending direction.

### CROSS-REFERENCE TO RELATED APPLICATION

This application claims priority from Japanese Patent Application No. 2013-092763 filed on Apr. 25, 2013, the entire subject matter of which is incorporated herein by reference.

### TECHNICAL FIELD

This disclosure relates to a display device. Specifically, this disclosure is applied to a thin display device such as a liquid crystal display device.

### BACKGROUND

A display device is used in various equipments, as an information display means for the observer. Currently, instead of a cathode ray tube that is a conventional mainstream, a new thin display device a liquid crystal, plasma, light emitting element (EL: Electro Luminescence), FED (Field Emission Display), or the like is currently used. Specifically, since the liquid crystal display device can be produced in a wide range of sizes from small to large model, the liquid crystal display device is considered as a representative thin display device.

FIG. 8 illustrates a liquid crystal panel configuring a liquid crystal display device, as an example of a display panel. Although not shown, a liquid crystal panel 101 has a structure in which an array substrate and a counter substrate are bonded to each other, and a liquid crystal is sealed in a gap therebetween, as in a known form.

Next, a display area 102 corresponding to a display part of the display device is described. Similar to a known form, in the display area 102, a plurality of pixels is arranged in a matrix form (not shown) and switching elements for controlling each pixel or wirings for supplying control signal or input signal are provided.

A mounting terminal (not shown) formed at an end of a wiring extending from the inside of the display area 102 is provided in a frame area 103 outside the display area 102. Electrical signal for display is inputted via the mounting terminal from a drive circuit.

As a mounting method of the drive circuit, there is a method of connecting TCP (Tape Carrier Package) or COF (Chip On Film) in which a driver IC 104 is formed on an insulative film (for example, see JP-A-2005-31332). Although the COF is illustratively described below, the similar description can be applied to the TCP.

In order to operate the thin display device, a mounting process of connecting the drive circuit 104 and a terminal on the display panel 101 is performed. Furthermore, a peripheral circuit mounting process of mounting the display panel 101 and a display control substrate 105 to each other via the COF 106 is performed. Here, the drive circuit is mounted on the display panel 101 and a circuit for controlling the driver IC or other circuits such as a power supply are mounted on the display control substrate 105. Generally, the source COF 106 and the display control substrate 105 are connected to each other.

### SUMMARY

It is general that rectangular COFs as shown in FIG. 8 are mounted on one side of the display panel with a required number since the mounting process and components management are easy. Here, recently, the display resolution is increased in accordance with the high definition of an image, so that the number of the source COF to be mounted is also increased with the improvement of the display resolution. In other words, when the display resolution is increased in the structure as shown in FIG. 8, the display control substrate also requires a COF mounting width as much as the width of multiple source COFs mounted on the display panel. As a result, there is a problem that the width of the display control substrate is widened than the suitable width.

In view of the above, A display device of this disclosure includes: a tape member, on which an input terminal, an output terminal and a drive circuit connected to the input terminal and the output terminal are formed; a rectangular display panel, which is connected to the tape member via the output terminal; and a display control substrate, which is connected to the tape member via the input terminal. A plurality of the tape members is provided along one side of the display panel, wherein a first tape member is one of the plurality the tape members and is provided at an end portion in an extending direction of the one side, wherein the first tape member has: a first side where the input terminal is provided; a second side where the output terminal is provided; and an outer side, which is close to the end portion in the extending direction of the one side, wherein at least a part of the outer side is inclined with respect to another side of the first tape member, so that a width of the first side is narrower than a width of the second side, and wherein the outer side close to the end portion of the one side is closer to the end portion of the one side than an end side of the display control substrate, which is a side close to the end portion of the one side in the extending direction.

According to this configuration, it is possible to reduce the size of the display control substrate, and thus it is possible to contribute to the cost down and lightweight of the display device.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a view illustrating an example of a configuration of related parts of a display device according to a first illustrative embodiment;

FIG. 2 is a view illustrating a source COF according to the first illustrative embodiment;

FIG. 3 is a view illustrating an example of a configuration of related parts of a display device according to a second illustrative embodiment;

FIG. 4 is a view illustrating an example of a configuration of related parts of a display device according to a third illustrative embodiment;

FIG. 5 is a view illustrating an example of a configuration of related parts of a display device according to a fourth illustrative embodiment;

FIG. 6 is a view illustrating an example of a configuration of related parts of a display device according to a fifth illustrative embodiment;

FIG. 7 is a view illustrating an example of a configuration of related parts of a display device according to a sixth illustrative embodiment; and

FIG. 8 is a view illustrating an example of a configuration of related parts of a display device according to a background art.

### DETAILED DESCRIPTION

### First Illustrative Embodiment

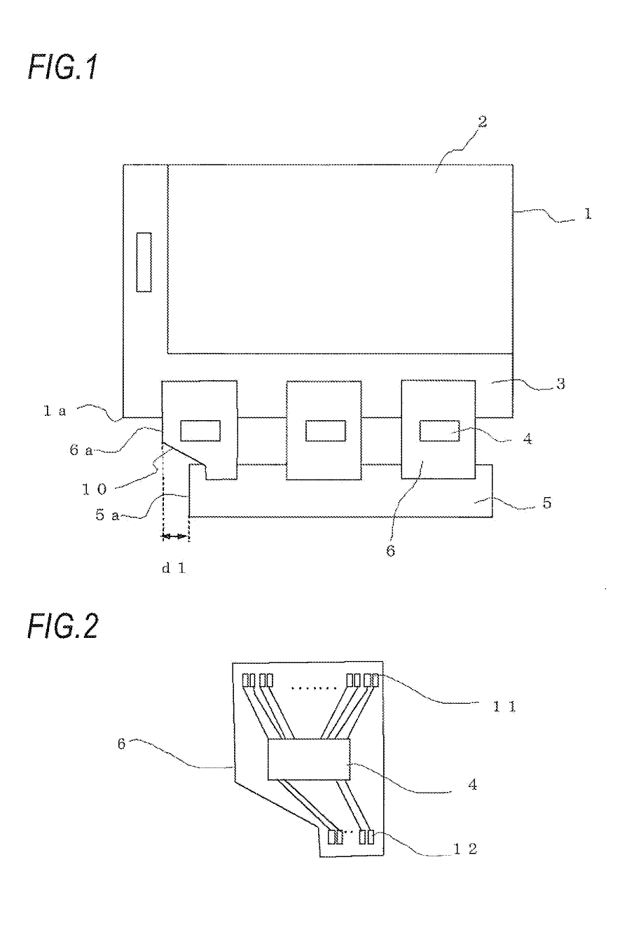

A first illustrative embodiment will be described with reference to FIG. 1. In FIG. 1, a display panel 1 is a liquid crystal panel configuring a liquid crystal display device, for example. The display panel 1 includes a display area 2 corresponding to a display screen of the liquid crystal display device and a frame area 3 located around the display area 2.

Similar to a known form, in the display area 2, a plurality of pixels is arranged in a matrix form (not shown) and switching elements for controlling each pixel or wirings for supplying control signal or input signal are provided. Meanwhile, in the frame area 3, a mounting terminal (not shown) formed at an end of a wiring extending from the inside of the display area 2 is provided. Electrical signal for displaying is inputted via the mounting terminal from a drive circuit.

The display panel 1 is connected to a display control substrate 5 via a driver IC 4 that is a drive circuit to be electrically connected to the mounting terminal. Here, since the driver IC 4 configures a source COF 6 by being formed on a tape member, it may be said that the display panel 1 is connected to the display control substrate 5 via the source COF 6, from a view of a structural point.

A plurality of source COFs 6 is formed along at least one side of the display panel 1 and the driver ICs 4 on the source COFs 6 are connected to a plurality of source wirings (not shown) that is formed in the display area 2. In the first illustrative embodiment, among a plurality of mounted source COFs 6, the source COF 6, which is a first tape member arranged in at least one of both end portions in a direction along one side of the display panel, is formed to have a shape 10 in which a side 6a close to an end portion 1a of the one side is obliquely cut so that at least a part of the side 6a is inclined. Here, the obliquely cut shape 10 is a shape, in which a side connected to the display panel 1 is wide and a side connected to the display control substrate 5 is narrow. Further, the end portion 1a is corresponding to not only an edge of the one side of the display panel 1 but also an adjacent area, as shown figures.

In order to assist in understanding the obliquely cut shape 10, the shape of such source COF 6 is described with reference to FIG. 2. In FIG. 2, the source COF 6 includes output terminals 11 mounted on the display panel 1 and input terminals 12 mounted on the display control substrate 5. The output terminals 11 and the input terminals 12 are provided in opposite sides facing each other. Here, a facing direction of the opposite sides is a direction parallel to an extending direction of the one side of the liquid crystal panel 1 on which a plurality of source COFs 6 is mounted.

The specific terminal number of the output terminals 11 and the input terminals 12 is set such that the number of the output terminals 11 is overwhelmingly greater than that of the input terminals 12. For example, the number of the output terminals is 702 and the number of the input terminals is 111 or the number of the output terminals is 1022 and the number of the input terminals is 115. Therefore, it can be understood that a width of the source COF 6 on the side where the input terminals 12 connected to the display control substrate 5 are provided is easily narrower than a width of the source COF 6 on the side (on the side to be connected to the display panel 1) where the output terminals 11 are provided.

Among a plurality of source COFs 6 that is provided along one side of the display panel 1 as shown in FIG. 1, the source COF 6 that is a first tape member provided at an end portion of the one side is formed to have the shape 10 in which the side 6a close to the end portion 1a of the one side is obliquely cut. In other words, by obliquely cutting the side 6a, the width of the source COF 6 on the side where the input terminals 12 connected to the display control substrate 5 are provided becomes narrower than the width of the source COF 6 on the side where the output terminals 11 are provided.

Therefore, in the source COF 6 provided at the end portion 1a of one side, the side 6a close to the end portion 1a of the one side is closer to the end portion 1a of the one side than an end side 5a of the display control substrate 5 on the side which is close to the end portion 1a of the one side. Specifically, the side 6a is closer to the end portion 1a of the display panel 1 than the end side 5a by a length d1, as shown in FIG. 1. This means that it is possible to shorten the width of the display control substrate 5 by at least the length d1.

The above source COF 6 is provided on at least one end of both end portions of the display panel 1, so that it is possible to reduce the size of the display control substrate 5, thereby achieving the cost down and lightweight of the display device.

Further, when the width of the source COF 6 on the side where the output terminals 11 are provided is wide, the layout of wirings, which extends from the terminals on the display panel 1 and drives each pixel, can be provided within the frame area having a narrow width, and further it is possible to reduce the outline of the panel, thereby achieving the cost down and lightweight of the display device.

In the first illustrative embodiment, since the type of the source COF to be used is increased by only one type, difficulty in the mounting process or components management is not caused.

Further, on a side (a gate side in the present illustrative embodiment) where the display control substrate 5 is not connected, a COF mounting or a COG mounting may be applied.

### Second Illustrative Embodiment

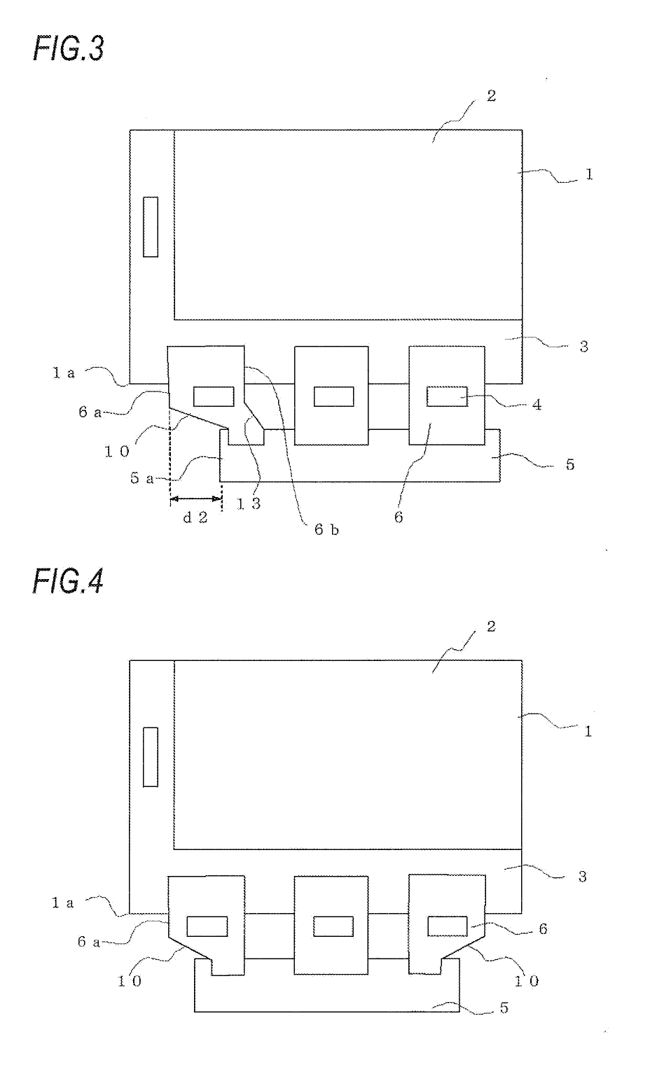

In the first illustrative embodiment, among a plurality of source COFs 6 that is provided along one side of the display panel 1, the COF positioned at a side of the end portion of the display panel is processed such that the side close to an end portion of the one side of the display panel is obliquely cut. A second illustrative embodiment is characterized in that not only the side of the COF close to the end portion of the one side of the display panel but also an opposite side of the COF is cut obliquely in the similar direction. FIG. 3 illustrates a display device according to the second illustrative embodiment.

As shown in FIG. 3, the second illustrative embodiment is similar to the first illustrative embodiment in that the display panel 1 and the display control substrate 5 are connected to each other via the source COFs 6. Further, the second illustrative embodiment is also similar to the first illustrative embodiment in that, among a plurality of source COFs 6 that is provided along one side of the display panel 1, the source COF 6 provided at an end portion of the one side is formed to have the shape 10 in which the side 6a close to the end portion 1a of the display panel 1 is obliquely cut. The second illustrative embodiment is characterized in that the source COF 6 provided at the end portion of the one side is formed to have a shape 13 in which an opposite side 6b of the side 6a close to the end portion 1a of the display panel 1, in other words, an opposite side 6b located farther from the end portion 1a of the display panel 1 than the side 6a is also obliquely cut.

Here, the obliquely cut direction in the obliquely cut shape 13 is a direction to be separated from the end portion 1a of the display panel 1, similar to the obliquely cut direction in the obliquely cut shape 10. In other words, the obliquely cut direction in the obliquely cut shape 10 is a direction narrowing the width of the source COF 6 at the display control substrate 5, and the obliquely cut direction in the obliquely cut shape 13 is a direction widening the width of the source COF 6 at the display control substrate 5.

The source COF 6 in the second illustrative embodiment is configured such that the side 6a close to the end portion 1a of the display panel 1 is closer to the end portion 1a of the display panel 1 than the end side 5a of the display control substrate 5 by a length d2. In other words, it is possible to shorten the width of the display control substrate 5 by at least the length d2. Here, as can be seen from FIG. 2, while the width of the source COF 6 on the side where the input terminals 12 are provided may be narrower than that of the source COF on the side where the output terminals 11 are provided, a certain degree of width is necessary. In the second illustrative embodiment, in the source COF 6 provided at the end portion, the opposite side 6b located farther from the end portion 1a of the display panel 1 is formed into the obliquely cut shape 13 so as to be separated from the end of the display panel 1. In this way, it is possible to secure a width of the source COF on the side of the input terminals 12 even when the length d2 is much longer than the length d1. In other words, the input terminals 12 can be located at a position that is further away from the end portion 1a, as compared to the shape shown in the first illustrative embodiment.

Accordingly, since the above source COF 6 is provided at least one end of both end portions of the display panel 1, the size of the display control substrate 5 can be further reduced as compared to the first illustrative embodiment, so that the cost down and lightweight of the display device is achieved. Further, since the input terminals are closer to the center of the display panel 1, the size (width) of the display control substrate can be further reduced, so that the cost down and lightweight of the display device is achieved. Also in the second illustrative embodiment, since the type of the source COF to be used is increased by only one type, difficulty in the mounting process or components management is not caused, similarly to the first illustrative embodiment.

### Third Illustrative Embodiment

In the first and second illustrative embodiments, a case has been described in which this disclosure is applied to only the COF 6 provided at either of both end portions, among a plurality of source COFs 6 that is mounted along one side of the display panel 1. A third illustrative embodiment is characterized in that a specific COF is used in each of the COFs provided at both end portions.

FIG. 4 illustrates a case where the source COF that is the first tape member shown in the first illustrative embodiment is applied to both end portions of one side of the display panel 1. Here, the source COF shown in the second illustrative embodiment may be applied to the both end portions. Alternatively, the COF shown in the first illustrative embodiment may be applied to one end and the source COF shown in the second illustrative embodiment may be applied to the other end. By using the COF of this disclosure at both end portions, the size of the display control substrate can be further reduced, so that the cost down and lightweight of the display device is achieved.

### Fourth Illustrative Embodiment

In a case where three or more source COFs 6 are mounted along at least one side of the display panel, the COF other than the COFs mounted on both end portions of the display panel 1 uses the same as either of the source COFs mounted on the both end portions. FIG. 5 illustrates a display device according to the fourth illustrative embodiment.

In FIG. 5, the fourth illustrative embodiment is similar to the third illustrative embodiment in that the display panel 1 and the display control substrate 5 are connected to each other via the source COFs 6, and among a plurality of source COFs 6 mounted along one side of the display panel 1, the source COFs 6 that are the first tape members located at both end portions are formed to have the shape 10 in which the side 6a close to the end portion 1a of the display panel 1 is obliquely cut. In the fourth illustrative embodiment, the other source COFs that are second tape members other than the source COFs 6 being the first tape members mounted on both end portions of the display panel 1 are formed to have a shape 14 in which a side 6c is obliquely cut. In other words, the source COFs that are the second tape members other than the source COFs that are the first tape members mounted on both end portions of the display panel 1 include a COF having the same shape as the source COF that are the first tape members mounted on both end portions of the display panel 1.

Accordingly, since the type of the source COF to be used is only two types, the mounting process and components management is easy, as compared to a case where three or more types of source COFs are used, so that the cost down of a product is achieved.

Although, in FIG. 5, a case has been described in which the total number of the source COF is three, the total number of the source COF may be four or more. In the case of using four or more source COFs, the source COFs other than the source COFs mounted on both end portions of the display panel 1 have the same shape as either of the source COFs mounted on both end portions. Therefore, the components management becomes easy.

### Fifth Illustrative Embodiment

In the first to fourth illustrative embodiments, all of the output terminals 11 of a plurality of source COFs 6 mounted along at least one side of the display panel 1 are extended in a direction parallel to an extending direction of the one side of the display panel 1. Furthermore, since the output terminals 11 and the input terminals 12 are formed on the sides facing each other, the side of the source COF 6 on which the input terminals 12 connected to the display control substrate 5 are formed is also extended in the direction parallel to the extending direction of the one side of the display panel 1. In other words, an connecting area of the display control substrate 5, which are connected to the source COFs 6 via the input terminals 12, are provided along the side extending in the direction parallel to the extending direction of the one side of the display panel 1. The fifth illustrative embodiment is different from the first to fourth illustrative embodiments in that connecting area of the display control substrate 5, which are connected to the source COFs 6 via the input terminals 12, are provided along a direction different from the extending direction of the one side of the display panel 1.

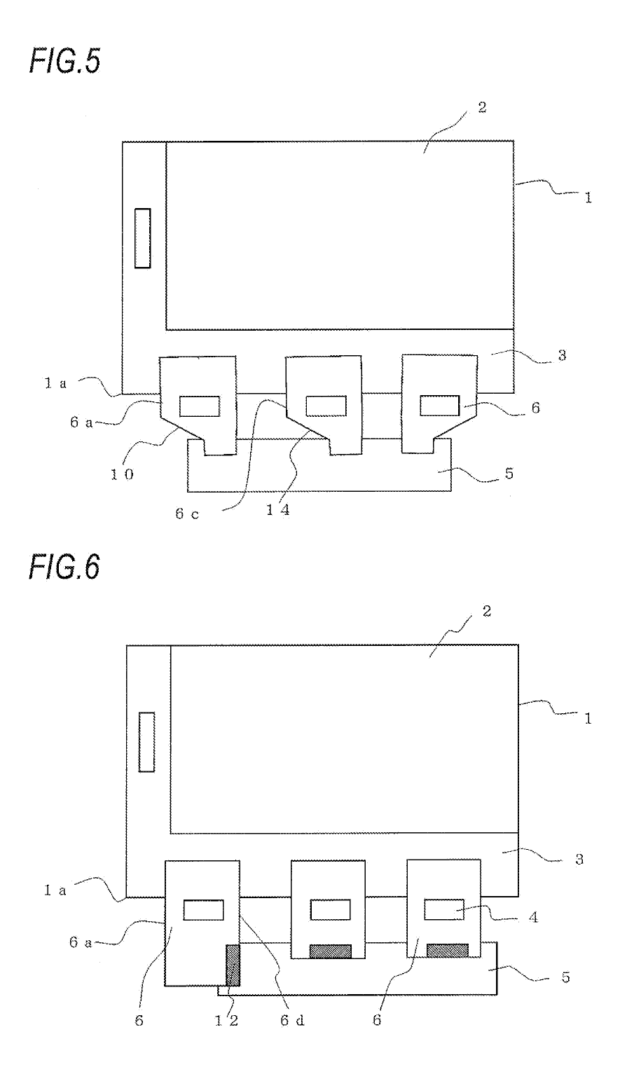

FIG. 6 illustrates a display device according to the fifth illustrative embodiment. As shown in FIG. 6, a plurality of source COFs 6 is mounted along at least one side of the display panel 1. In the source COF 6 that is the first tape member provided at either of both end portions of the one side, an area on which the input terminals 12 are formed is provided at a side 6d that is closer to the center of the one side than the end portion 1a of the display panel 1, instead of a side opposite to the side on which the output terminals 11 are arranged. In other words, among a plurality of mounted source COFs 6, the source COF 6 that is the first tape member located at either of both end portions in a extending direction along the one side of the display panel 1 includes the input terminals 12 which are connected to the side 6d of the display control substrate 5, which is provided in a direction different from the extending direction of the one side of the display panel 1. In FIG. 6, the side 6d is provided at a position opposite to the side 6a close to the end portion 1a of the display panel 1.

Furthermore, since the above source COF is provided on only one of both end portions of one side of the display panel 1, it is possible to reduce the size of the display control substrate, so that the cost down and lightweight of the display device is achieved. Further, when the width of the source COF 6 on the side where the output terminals 11 are provided is wide, the layout of wirings, which extends from the terminals on the display panel 1 and drives each pixel, can be provided in the frame area having a narrow width and further the outline of the panel is reduced, so that the cost down and lightweight of the display device is achieved.

Furthermore, similar to the first to fourth illustrative embodiments, in the source COF 6 provided at an end portion of the one side among a plurality of source COFs 6 mounted along one side of the display panel 1, the side 6a close to the end portion 1a of the display panel 1 is closer to the end of the display panel 1 than the end side 5a of the display control substrate 5. In other words, similar to the first to fourth illustrative embodiments, it is possible to shorten the length of the display control substrate 5.

Here, since the type of the source COF to be used is increased by only one type, difficulty in the mounting process or components management is not caused. Further, on a side (a gate side in the present illustrative embodiment) where the display control substrate 5 is not connected, a COF mounting or a COG mounting may be applied.

### Sixth Illustrative Embodiment

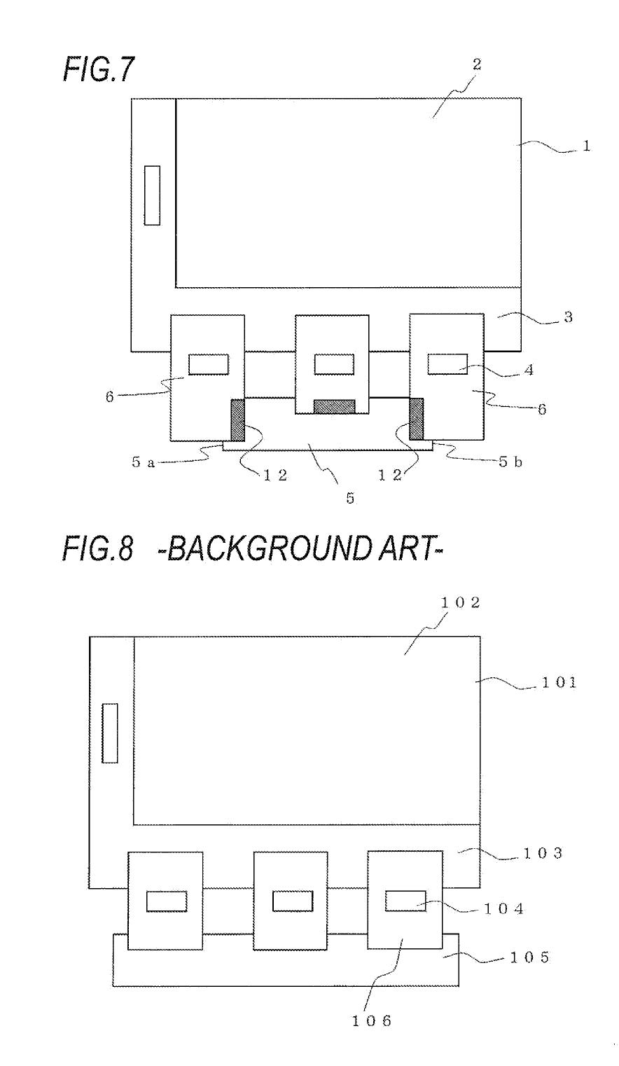

In the fifth illustrative embodiment, a COF type in which the input terminals 12 are provided at the side 6d closer to the center of the one side of the display panel 1 is applied to only one of the source COFs provided at both end portions, among a plurality of source COFs 6 mounted along one side. In the sixth illustrative embodiment, a specific source COF is used in each of the source COFs provided at both end portions. This type is shown in FIG. 7. As shown in FIG. 7, the source COFs 6 are connected to the display control substrate 5 via the input terminals 12, at both end sides 5a, 5b of the display control substrate 5.

In the sixth illustrative embodiment, the above source COFs is applied to both end portions of one side of the display panel 1, unlike the fifth illustrative embodiment in which the COF type of this disclosure is applied to only one of both end portions thereof. Therefore, it is possible to further reduce the size (width) of the display control substrate, so that the cost down and lightweight of the display device is achieved.

Although a case of mounting a display panel to be used in a liquid crystal display device has been described in the sixth illustrative embodiment, this disclosure can be applied to a display device such as an electroluminescence.

Further, although the COF is illustratively described as a tape member in the illustrative embodiments, this disclosure may be applied to other forms using a tape member to which a driver IC is fixed. For example, this disclosure can be applied to TCP. It is noted that the tape member described herein is used as a general term without distinction of the first tape member and the second tape member, which are intended for specifying the position thereof. When the TCP is used as the tape member, the TCP will be applied to both the first tape member and the second tape member. However, this disclosure may be applied to a case where both the TCP and COF are used.

What is claimed is:

1. A display device comprising:
a tape member, on which an input terminal, an output terminal and a drive circuit connected to the input terminal and the output terminal are formed;
a rectangular display panel, which is connected to the tape member via the output terminal; and
a display control substrate, which is connected to the tape member via the input terminal,
wherein a plurality of the tape members is provided along one side of the display panel,
wherein a first tape member is one of the plurality the tape members and is provided at an end portion in an extending direction of the one side,
wherein the first tape member has: a first side where the input terminal is provided; a second side where the output terminal is provided; and an outer side, which is close to the end portion in the extending direction of the one side,
wherein at least a part of the outer side is inclined with respect to another side of the first tape member, so that a width of the first side is narrower than a width of the second side, and
wherein the outer side close to the end portion of the one side is closer to the end portion of the one side than an end side of the display control substrate, which is a side close to the end portion of the one side in the extending direction.

2. The display device according to claim 1,
wherein an opposite side is a side opposite to the outer side close to the end portion of the one side, and
wherein at least a part of the opposite side is inclined to be separated from the end portion of the one side.

3. The display device according to claim 1,
wherein the first tape member is provided at both end portions in the extending direction of the one side of the display panel.

4. The display device according to claim 3,
wherein three or more tape members are connected to the display control substrate, and
wherein at least one of the tape members other than the tape members provided at both end portions of one side of the display panel has the same shape as the first tape member.

5. A display device comprising:
a tape member, on which an input terminal, an output terminal and a drive circuit connected to the input terminal and the output terminal are formed,
a rectangular display panel, which is connected to the tape member via the output terminal; and
a display control substrate, which is connected to the tape member via the input terminal,
wherein a plurality of tape members is provided along one side of the display panel, and
wherein a first tape member is provided at at least one of both end portions of the one side,
wherein the input terminal is provided at an inner side of the first tape member, which is a side that extends in a direction different from an extending direction of the one side of the display panel and close to a center of the display panel.

6. The display device according to claim 5,
wherein the first tape member is provided at both end portions of the one side.

7. The display device according to claim 1,
wherein the tape member is a TCP (Tape Carrier Package) or COF (Chip On Film).
